(19) United States
(12) Patent Application Publication
(10) Pub. No.: US 2017/0259478 A1
(43) Pub. Date: Sep. 14, 2017

(54) METHOD FOR IN-MOLD MANUFACTURING OF A DECORATIVE STRUCTURAL PLASTIC PART SUCH AS AN AIR REGISTER LOUVER

(71) Applicant: FORD GLOBAL TECHNOLOGIES, LLC, Dearborn, MI (US)

(72) Inventors: Robert Duane Bedard, Allen Park, MI (US); George David Koch Smith, Lake Orion, MI (US)

(21) Appl. No.: 15/065,490

(22) Filed: Mar. 9, 2016

(51) Int. Cl. B29C 45/16; B29C 45/40; B29C 45/14

(52) U.S. Cl. CPC B29C 45/1679; B29C 45/14065; B29C 45/40; B29K 2077/00

(57) ABSTRACT

A decorative structural plastic part is provided. That part includes an integral body having a structural plastic layer, a decorative face formed from an in-mold-decoration or IMD and an IMD-compatible plastic layer bridging between the structural plastic layer and the IMD. A mechanical bond locks the structural plastic layer with the IMD-compatible plastic layer. A method for making the part is also disclosed.

### TECHNICAL FIELD

This document relates generally to the production of decorative structural plastic parts and, more particularly, to the production of an automotive air register louver from a structural plastic resin, an in-mold-decoration compatible plastic resin and an in-mold-decoration wherein a completely finished part is ejected from the mold.

### BACKGROUND

Air registers, which are responsible for directing air flow to the vehicle occupants, are also important aesthetic elements that contribute to the overall style and theme of an automotive cockpit. Currently there are multiple techniques utilized in the industry to decorate the louvers or vanes of air registers.

As illustrated in FIG. 1a, such a louver L may include a body B molded from a non-structural resin, such as acrylonitrile butadiene styrene (ABS), polycarbonate+acrylonitrile butadiene styrene (PC+ABS) or acrylonitrile styrene acrylate (ASA), which is injected into a mold that already holds an in-mold-decoration (IMD). The IMD is applied directly to the facing E of the resulting louver L via the heat and pressure characteristic of the molding process.

Significantly, an IMD will only adhere to certain materials which are characterized as non-structural resins. Due to the stiffness requirements for air register louvers, only short vanes may be molded with IMD compatible resins. Longer louvers require structural plastic resins such as glass-filled materials including polyamide which do not adhere well to IMDs without the application of pretreatment or external adhesives thereby complicating the production process and adding significantly to production costs.

FIG. 1b illustrates another technique used in the industry for decorating air register louvers. In this technique, the body B of the louver L is formed from a stronger glass-filled polyamide. However, as noted above, that structural plastic resin cannot properly accept an IMD directly. Therefore, a separate cap C is molded from a non-structural resin/IMD-compatible material that will accept the IMD. That separate cap C is then manually installed and adhesively bonded to the polyamide louver to provide the decorative appearance. More specifically, the lug G formed on the polyamide body B is pressed into and received in the notch N formed in the cap C. An adhesive A bonds the cap C and body B together. As should be appreciated, this louver manufacturing process comprises multiple component parts and steps which increase production costs and inherently include a large number of failure modes.

This document presents an innovative method for marrying IMDs with structural resins wherein a structural plastic resin, an IMD-compatible plastic resin and an IMD are placed inside a mold and a finished plastic part is ejected. While such a process is particularly useful for the production of air register louvers, other decorate plastic parts may also be made.

### SUMMARY

In accordance with the purposes and benefits described herein, a decorative structural plastic part is provided. That decorative structural plastic part comprises a structural plastic layer, an IMD-compatible plastic layer, a mechanical bond between the structural plastic layer and the IMD-compatible plastic layer and an IMD bonded to the IMD-compatible plastic layer.

The mechanical bond may include interdigitating sections of the structural plastic layer and the IMD compatible plastic layer. In some embodiments, the mechanical bond forms a dovetail connection. In some embodiments, the decorative structural plastic part may be an air register louver for a motor vehicle.

The structural plastic layer may be made from a material selected from a group consisting of 50% glass-filled polyamide 6 (PA6), 60% glass-filled polyamide 6 (PA6), 50% glass-filled polyamide 66 (PA66), 60% glass-filled polyamide 66 (PA66), 55% glass-filled polybutylene terephthalate (PBT) or mixtures thereof. The IMD-compatible plastic layer may be made from a material selected from a group consisting of acrylonitrile butadiene styrene (ABS), polycarbonate+acrylonitrile butadiene styrene (PC+ABS), acrylonitrile styrene acrylate (ASA) or mixtures thereof. Still further, the IMD may be a decorative foil or a decorative film.

In accordance with an additional aspect, an air register louver is provided for a motor vehicle. That air register louver comprises an integral body including a structural plastic layer, an IMD and an IMD-compatible plastic layer bridging between the structural plastic layer and the IMD.

Still further, a method is provided for producing a decorative structural plastic part in a mold. That method may be broadly described as comprising two-shot molding a structural plastic layer and an IMD-compatible plastic layer with an IMD in a mold and removing the finished decorative structural plastic part from the mold.

More specifically, the method may include injecting a structural plastic resin into the mold to form a structural plastic layer. Further, the method may include the step of positioning an IMD into the mold. Still further, the method may include the step of injecting an IMD-compatible plastic resin into the mold between the structural plastic layer and the IMD and transferring the IMD to the IMD-compatible plastic layer.

Still further the method may include the step of mechanically bonding the structural plastic layer with the IMD-compatible plastic layer. Such a mechanical bonding may include the step of forming channels in the structural plastic layer by injecting the structural plastic resin against a first mold section and a second mold section. Next is the replacing of the first mold section of the mold with a third mold section while maintaining the structural plastic layer in a second mold section. This is followed by positioning an IMD into the mold while the mold is open. Following mold closing, is the injecting of the IMD-compatible plastic resin into the mold between the structural plastic layer and the IMD. This serves to push the IMD against the third mold section and adhere the IMD to a surface of the IMD-compatible layer.

The method may further include the step of curing the portion of the IMD-compatible layer in the channels formed in the structural plastic layer thereby forming a mechanical lock feature. That mechanical lock feature comprises interdigitating portions of the structural plastic layer and the IMD-compatible layer.

In the following description, there are shown and described several preferred embodiments of the method as well as the decorative structural plastic part or air register louver made by means of the method. As it should be realized, the method, the part and the louver are capable of other, different embodiments and their several details are capable of modification in various, obvious aspects all without departing from the method, part and louver as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the method, the part and the louver and together with the description serve to explain certain principles thereof. In the drawing figures:

FIG. 1a is a schematic illustration of the structure of a decorative prior art louver including a base layer or body of non-structural resin having a face covered with an IMD.

FIG. 1b is a schematic illustration of another embodiment of prior art air register louver including a principle body formed from a structural resin, a cap formed from a non-structural/IMD-compatible resin with a face of that cap covered by an IMD.

FIG. 2 is a detailed schematic view illustrating a decorative structural plastic part or air register louver produced in accordance with the method described herein.

FIG. 3 is a perspective view of a motor vehicle air register including a plurality of louvers or vanes that may be made in accordance with the method described herein.

FIGS. 4a-4e are a series of schematic illustrations relating to the current method for producing a decorative structural plastic part or an air register louver.

FIG. 5 illustrates an alternative method step.

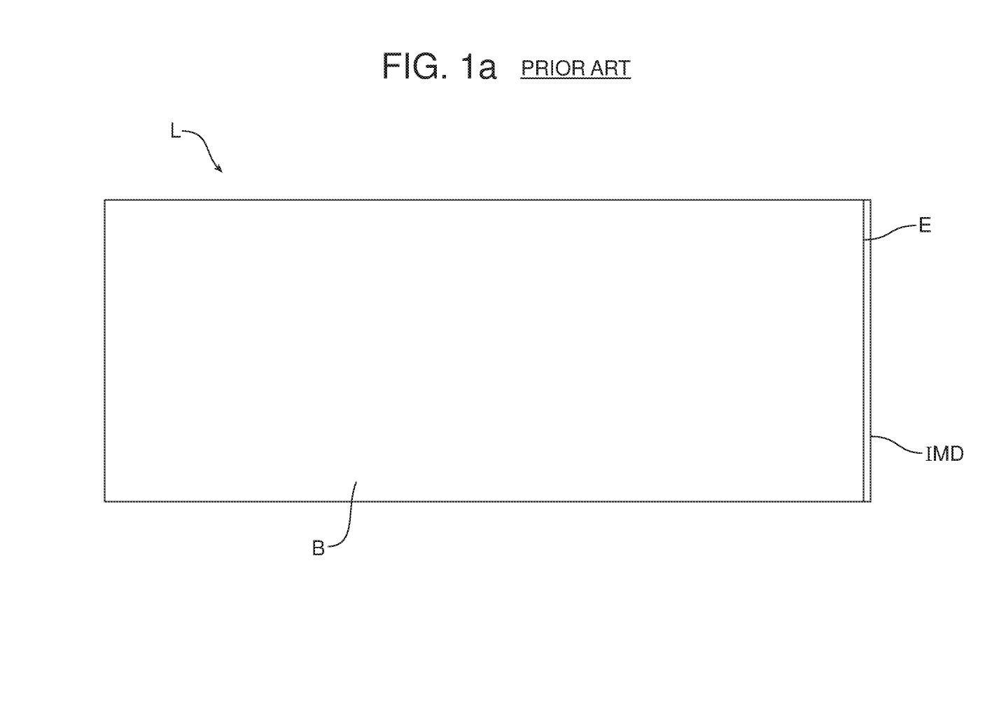

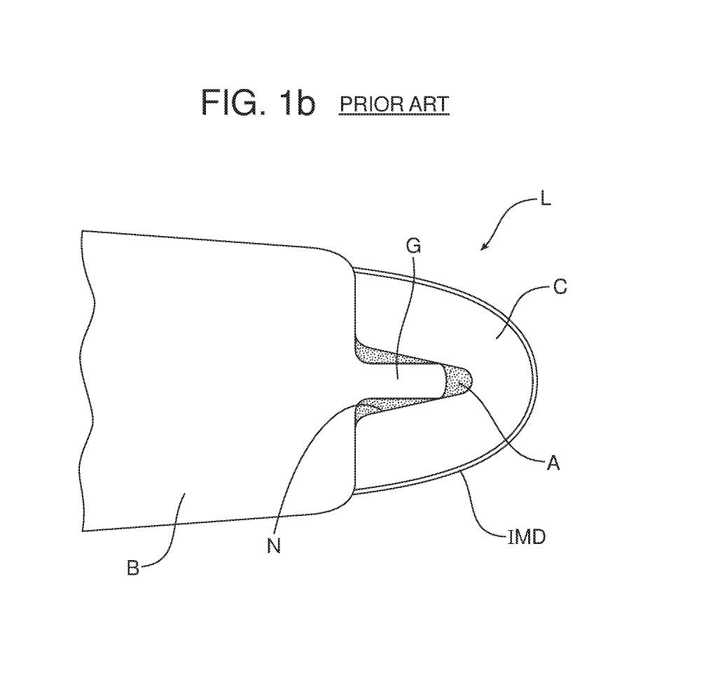

Reference will now be made in detail to the present preferred embodiments of the method, decorative structural plastic part and air register louver, examples of which are illustrated in the accompanying drawing figures.

### DETAILED DESCRIPTION

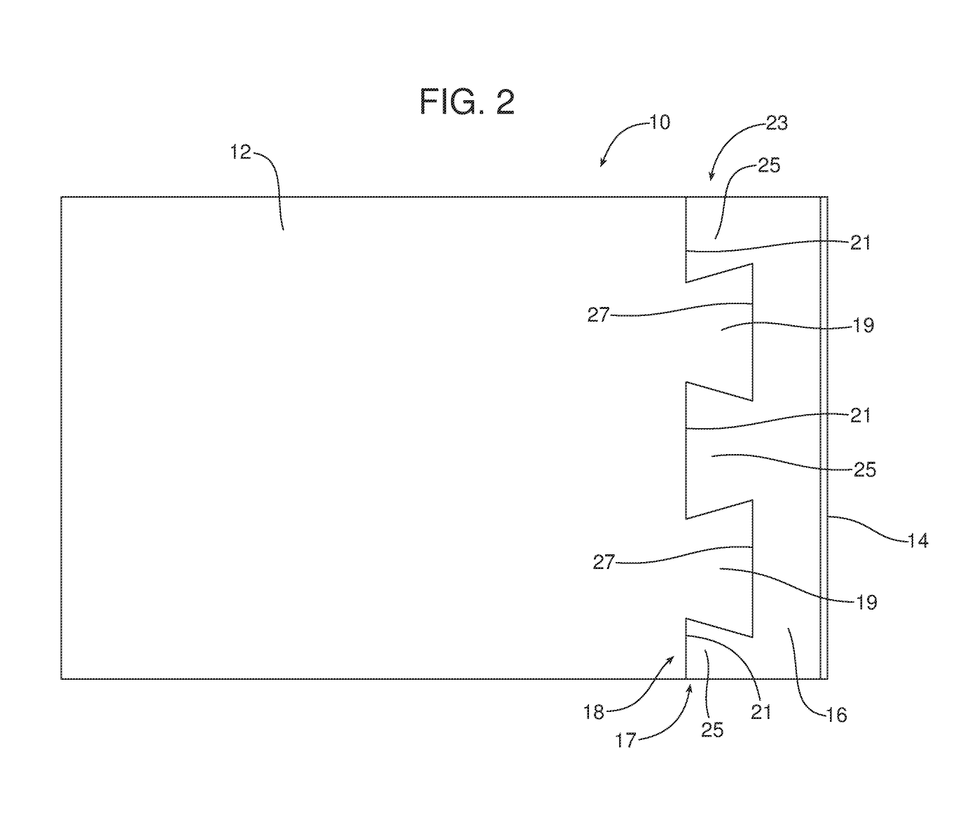

Reference is now made to FIG. 2 illustrating a decorative structural plastic part 10 which comprises an integral body including a structural plastic layer or section 12, an in-mold-decoration or IMD 14 and an IMD-compatible plastic layer or section 16 bridging between the structural plastic layer and the IMD. As illustrated, a mechanical bond, generally designated by reference numeral 18, is provided between the structural plastic layer 12 and the IMD-compatible plastic layer 16. In the illustrated embodiment that mechanical bond 18 includes a first set 17 of alternating projections 19 and channels 21 in the structural plastic layer 12 and a second set 23 of alternating projections 25 and channels 27 in the IMD-compatible plastic layer 16. The first and second sets 17, 23 are complimentary so that the alternating projections 19, 25 and channels 21, 27 are interdigitating. As illustrated in FIG. 2, the mechanical bond 18 may form a dovetail connection in some embodiments/applications.

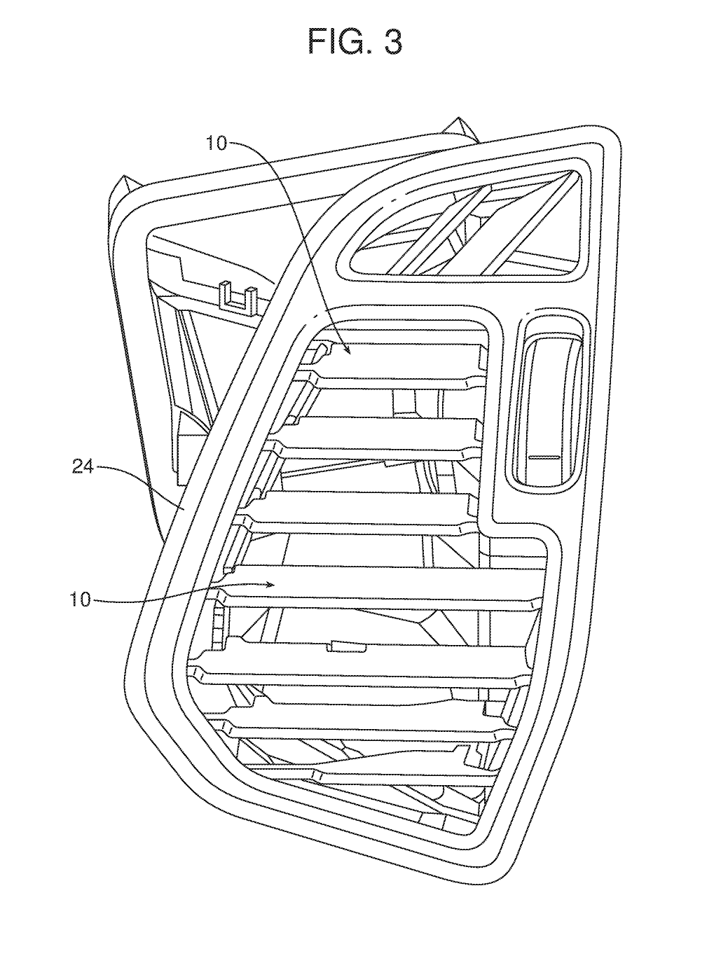

As illustrated in FIG. 3, the decorative structural plastic part 10 may comprise an air register louver for an air register 24 of a motor vehicle. In some embodiments, the structural plastic layer 12 is made from the structural plastic resin or material selected from a group consisting of 50% glass-filled polyamide 6 (PA6), 60% glass-filled polyamide 6 (PA6), 50% glass-filled polyamide 66 (PA66), 60% glass-filled polyamide 66 (PA66), 55% glass-filled polybutylene terephthalate (PBT) or mixtures thereof. Further, in some embodiments the IMD-compatible plastic layer 16 may be made from a non-structural plastic resin or material selected from a group consisting of acrylonitrile butadiene styrene (ABS), polycarbonate+acrylonitrile butadiene styrene (PC+ABS), acrylonitrile styrene acrylate (ASA) or mixtures thereof. The IMD 14 may be a decorative foil or decorative film such as a type known in the art that may be transferred onto an IMD-compatible plastic layer from a carrier tape or the like.

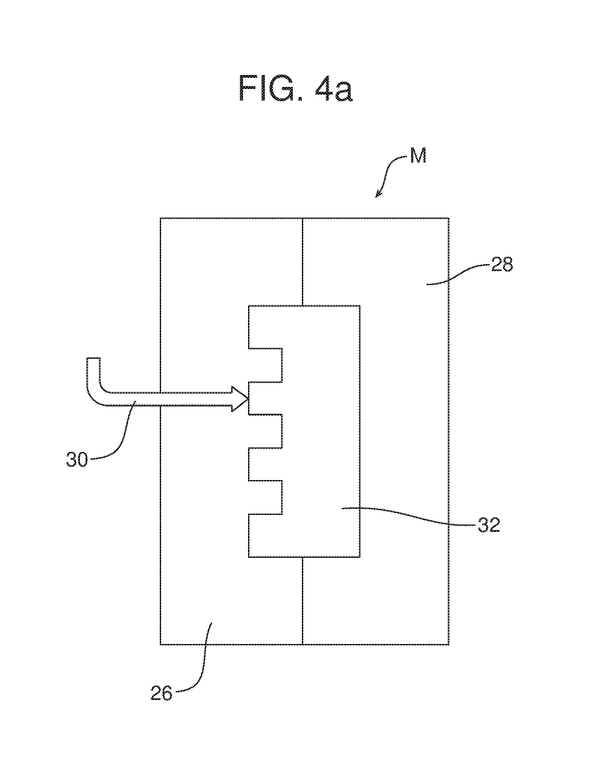

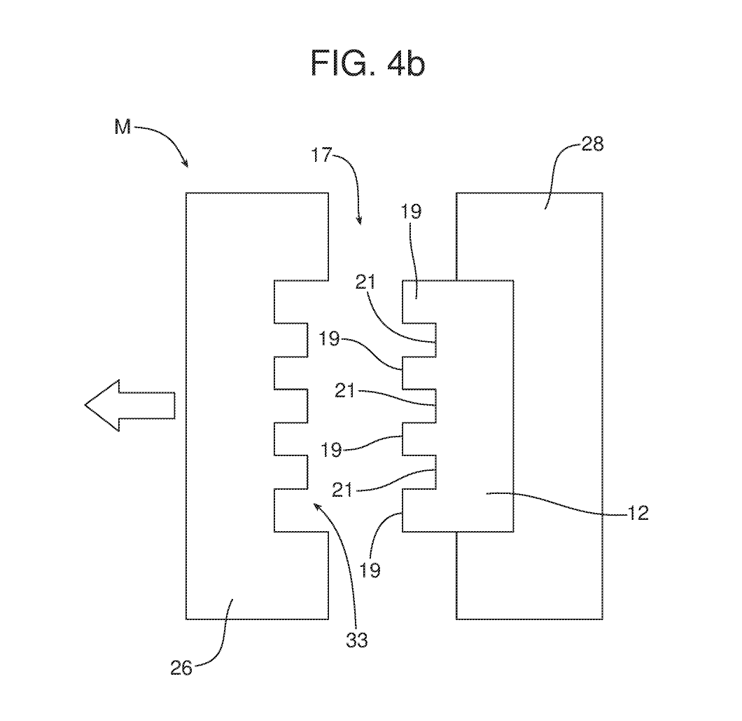

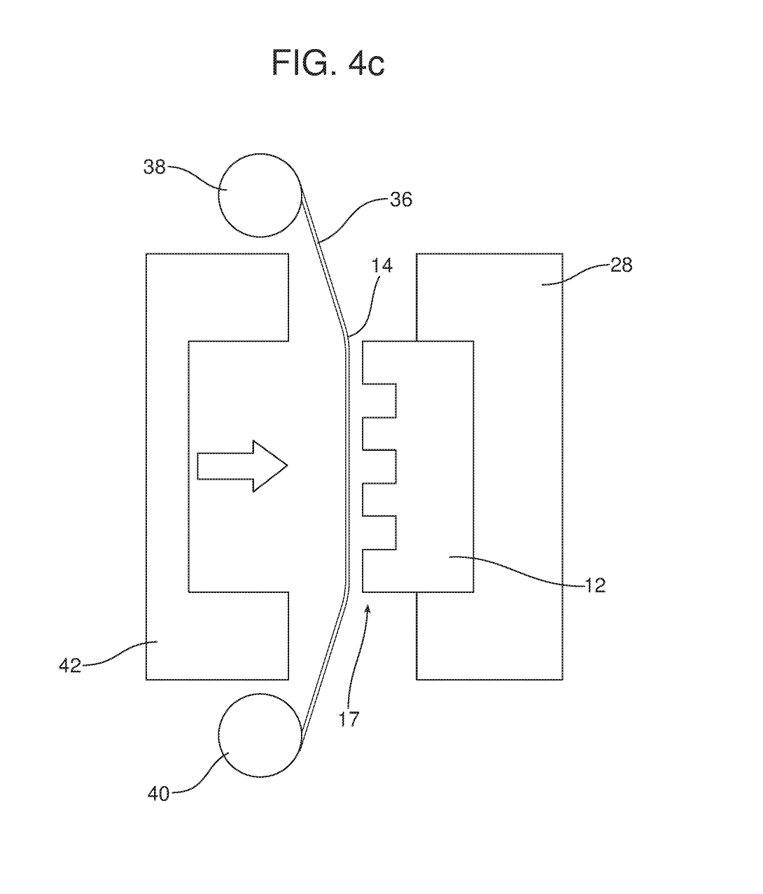

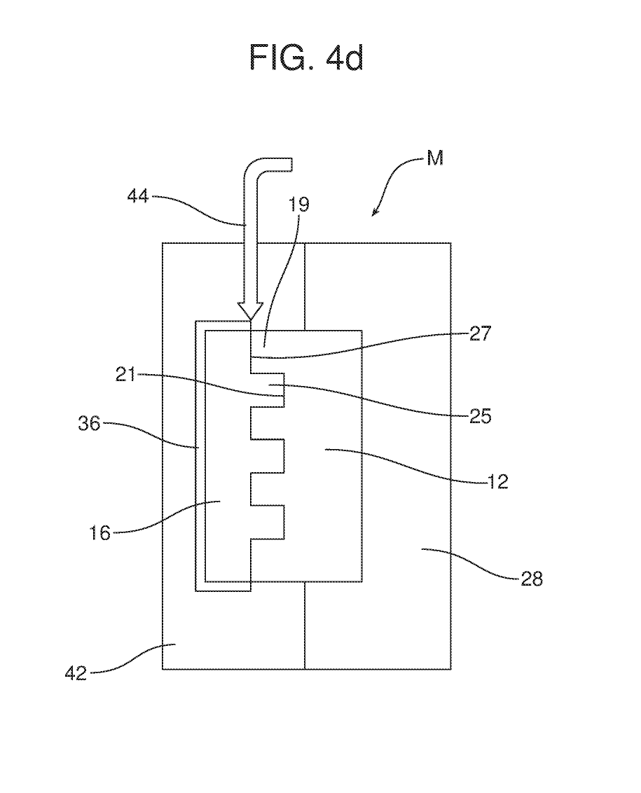

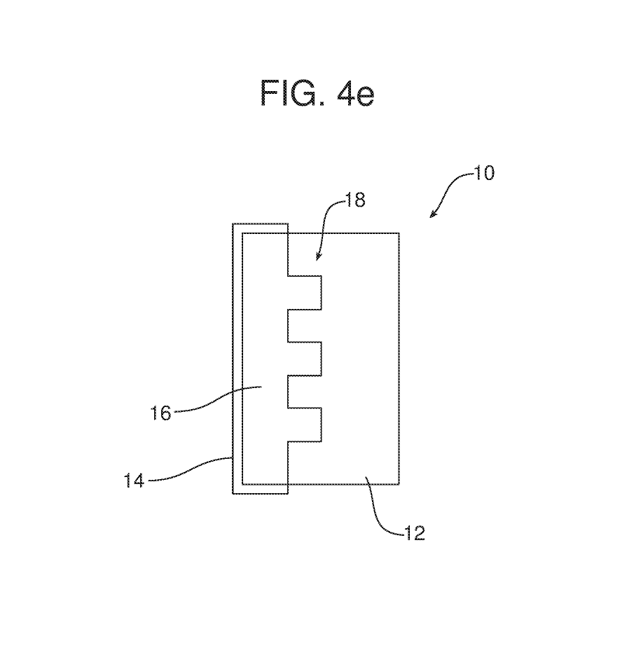

Reference is now made to FIGS. 4a-4e which generally illustrate a method of producing the decorative structural plastic part or air register louver 10 in a mold M. That method may be broadly described as including the steps of: (a) two-shot molding a structural plastic layer 12 and an IMD-compatible plastic layer 16 with an IMD 14 in a mold M and (b) removing a finished decorative structural plastic part or louver 10 from the mold. As should be appreciated from reviewing FIGS. 4a-4e, the method may also include the step of forming a mechanical bond 18 between the structural plastic layer 12 and the IMD-compatible plastic layer 16 in the mold M.

As illustrated in FIG. 4a, the mold M includes a first mold section 26 and a second mold section 28 which are closed together. This is followed by the injecting of a structural plastic resin 30 into the cavity 32 defined by the first and second sections 26, 28 of the mold M. Once the plastic resin 30 is sufficiently cured to maintain the shape of the structural plastic layer 12, the mold M is opened while the structural plastic layer 12 is retained in the second mold section (see FIG. 4b). As illustrated, the structural plastic layer 12 includes a face 33 shaped and adapted to form the first set 17 of alternating projections 19 and channels 21 in the structural plastic layer 12.

As illustrated in FIG. 4c, an IMD on a carrier web 36 extends between a feed roll 38 and a takeup roll 40. The IMD carrier web 36 is aligned over the structural plastic layer 12 in the second mold section 28 and a third mold section 42 is aligned with the second mold section 28 and the two sections of the mold M are then closed so as to capture the IMD carrier web. As illustrated in FIG. 4d, an IMD-compatible plastic resin 44 is then injected into the cavity of the mold M between the structural plastic layer 12 and the IMD carrier web 36. The injected IMD-compatible plastic resin 44 presses the IMD carrier web 36 against the third mold section 42 and the resulting heat and pressure transfers the IMD 14 from the IMD carrier web 36, adhering the IMD to the face of the now-curing IMD-compatible plastic layer 16. Simultaneously, the first set 17 of alternating projections 19 and channels 21 functions as a mold profile for (a) forming the second, complimentary set 23 of alternating projections 25 and channels 27 in the IMD-compatible plastic layer 16 and (b) mechanically bonding the layers 12, 16 together. The mold M is then opened and the finished decorative structural plastic part 10 with an integral structural plastic layer 12, IMD-compatible plastic layer 16 and IMD 14 is removed from the mold (see FIG. 4e). The IMD carrier web 36 is then advanced from the feed roll 38 toward the takeup roll 40 to prepare for the production of the next decorative structural plastic part 10.

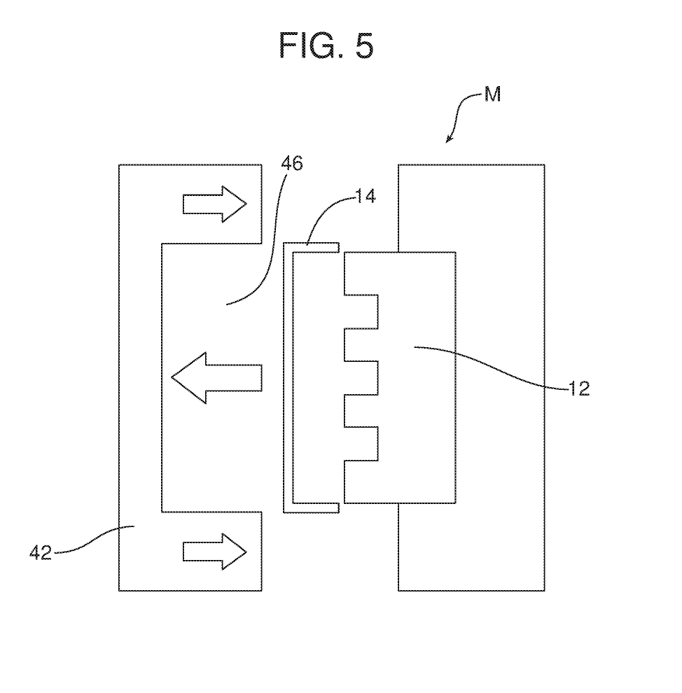

In an alternative embodiment illustrated in FIG. 5, an IMD 14 in the form of an applique is positioned in the cavity 46 of the third mold section 42 before closing the mold M and injecting the IMD-compatible plastic resin between the applique and the structural plastic layer 12. Thus, in this embodiment, the IMD applique 14 replaces the IMD carrier web 36 eliminating the need for the use of the feed and takeup rolls 38, 40.

As should be appreciated, the disclosed method allows the efficient and relatively inexpensive production of a decorative structural plastic part 10, such as an air register louver. In accordance with the method, a structural plastic resin 30, an IMD 14 and an IMD-compatible/non-structural plastic resin 44 are added to a mold M and a finished part 10 is removed from the mold. That finished part 10 includes a structural plastic layer 12 and an IMD-compatible plastic layer 16 which are secured together by the first and second complimentary sets 17, 23 of alternating projections 19, 25 and channels 21, 27 that are interdigitated together to form a mechanical bond 18. The heat and pressure of the molding process ensures the transfer and adhesion of the IMD to the IMD-compatible plastic layer 16. As a result, the decorative structural plastic part/louver 10 is a single integral body comprising a structural plastic layer 12, the IMD-compatible plastic layer 16 and the IMD 14.

The foregoing has been presented for purposes of illustration and description. It is not intended to be exhaustive or to limit the embodiments to the precise form disclosed. Obvious modifications and variations are possible in light of the above teachings. For example, in the method embodiment illustrated in FIGS. 4a-4e, the structural plastic layer 12 is molded and partially-cured before the IMD-compatible plastic layer 16. This is done when the structural plastic layer 12 has a higher softening point temperature than the IMD-compatible plastic layer 16. In any situation where the IMD-compatible plastic layer 16 has a higher softening point temperature than the structural plastic layer 12, the IMD-compatible plastic layer 16 would be molded with the IMD prior to the injecting and molding of the structural plastic layer 12. Further, it should be appreciated that the mechanical bond 18 may take another form such as holes in the structural plastic layer 12 which receive locking posts of the IMD-compatible plastic layer 16. All such modifications and variations are within the scope of the appended claims when interpreted in accordance with the breadth to which they are fairly, legally and equitably entitled.

1. A decorative structural plastic part, comprising:
a structural plastic layer;
an IMD-compatible plastic layer;
a mechanical bond between said structural plastic layer and said IMD-compatible plastic layer; and
an IMD bonded to said IMD-compatible plastic layer.

2. The decorative structural plastic part of claim 1, wherein said mechanical bond includes interdigitating sections of said structural plastic layer and said IMD-compatible plastic layer.

3. The decorative structural plastic part of claim 2, wherein said mechanical bond forms a dovetail connection.

4. The decorative structural plastic part of claim 1, wherein said decorative structural plastic part is an air register louver for a motor vehicle.

5. The decorative structural plastic part of claim 4, wherein said structural plastic layer is made from a material selected from a group consisting of 50% glass-filled polyamide 6, 60% glass-filled polyamide 6, 50% glass-filled polyamide 66, 60% glass-filled polyamide 66, 55% glass-filled polybutylene terephthalate or mixtures thereof.

6. The decorative structural plastic part of claim 5, wherein said IMD-compatible plastic layer is made from a material selected from a group consisting of acrylonitrile butadiene styrene, polycarbonate and acrylonitrile butadiene styrene, acrylonitrile styrene acrylate or mixtures thereof.

7. The decorative structural plastic part of claim 6, wherein said IMD is a decorative foil or decorative film.

8. An air register louver for a motor vehicle, comprising:
an integral body including a structural plastic layer, an IMD and an IMD-compatible plastic layer bridging between said structural plastic layer and said IMD.

9. A method of producing a decorative structural plastic part in a mold, comprising:
two-shot molding a structural plastic layer and an IMD-compatible plastic layer with an IMD in a mold; and
removing a finished decorative structural plastic part from said mold.

10. The method of claim 9 including forming a mechanical bond between said structural plastic layer and said IMD-compatible plastic layer in said mold.

11. The method of claim 9, including injecting a structural plastic resin into said mold to form said structural plastic layer.

12. The method of claim 11, including positioning an IMD into said mold.

13. The method of claim 12, including injecting an IMD-compatible plastic resin into said mold between said structural plastic layer and said IMD and transferring said IMD to said IMD-compatible plastic layer.

14. The method of claim 13, including mechanically bonding said structural plastic layer with said IMD-compatible plastic layer.

15. The method of claim 14, including forming channels in said structural plastic layer by injecting said structural plastic resin against a first mold section of said mold.

16. The method of claim 15, including replacing said first mold section of said mold with a third mold section while maintaining said structural plastic layer in said second mold section.

17. The method of claim 16, including positioning said IMD into said mold while said mold is open.

18. The method of claim 17, including injecting said IMD-compatible plastic resin into said mold between said structural plastic layer and said IMD, pushing said IMD against said third mold section and adhering said IMD to a surface of said IMD-compatible layer.

19. The method of claim 18, including curing a portion of said IMD-compatible layer in said channels formed in said structural plastic layer thereby forming a mechanical lock feature.

20. The method of claim 19, including providing a mechanical lock feature that comprises interdigitating portions of said structural plastic layer and said IMD-compatible layer.
